(19) United States
(12) Patent Application Publication
(10) Pub. No.: US 2014/0012944 A1
(43) Pub. Date: Jan. 9, 2014

(54) INFORMATION DISTRIBUTION APPARATUS, SIGNAGE SYSTEM AND METHOD FOR DISTRIBUTING CONTENT DATA

(71) Applicant: TOSHIBA TEC KABUSHIKI KAISHA, Tokyo (JP)

(72) Inventor: Takahide Kubota, Shizuoka-ken (JP)

(21) Appl. No.: 13/922,426

(22) Filed: Jun. 20, 2013

(30) Foreign Application Priority Data
Jul. 4, 2012 (JP) 2012-150669

(51) Int. Cl. H04L 29/08

(52) U.S. Cl. CPC H04L 67/02
USPC 709/217

(57) ABSTRACT

An information distribution apparatus includes an information input section which inputs information of a person within an area from a signage terminal, a category determination section which determines category of the person based on the information of the person inputted, a storage section which collects a statistics data on the determination result for each unit time in association with day and time of the week, to store the statistics data in a first storage section as attribute tendency information of the person per unit time, a content selection section which selects the content data to which meta-information relating to the attribute tendency information is added, with reference to a second storage section at a timing, a time schedule creation section which creates a time schedule for reproducing the content data, and a distribution section which distributes the content data to the signage terminal.

### CROSS-REFERENCE TO RELATED APPLICATION

This application is based upon and claims the benefit of priority from Japanese Patent Application No. 2012-150669, filed Jul. 4, 2012, the entire contents of which are incorporated herein by reference.

### FIELD

Embodiments described herein relate to an information distribution apparatus, a signage system and a method for distributing a content data.

### BACKGROUND

As an apparatus indicating a content such as an advertisement, an event or a message to unspecified persons, an information display system, i.e., a so-called digital signage system, is known, which displays a digitized content on a display device such as a signage terminal and the like. In such a digital signage system, an attribute of a viewer who stops at the signage terminal is determined, and a content to be displayed is selected according to the determination result.

### BRIEF DESCRIPTION OF THE DRAWINGS

FIG. 1 is a block diagram illustrating a schematic configuration of a signage system according to an embodiment;

FIG. 2 is an external front view of a signage terminal;

FIG. 3 is a block diagram illustrating a schematic configuration of the signage terminal;

FIG. 4 is a block diagram illustrating a schematic configuration of an information distribution server;

FIG. 5 is a diagram illustrating a structure of data stored in a content database;

FIG. 6 is a diagram illustrating a structure of data stored in an attribute database;

FIG. 7 is a block diagram illustrating a functional construction of the information distribution server;

FIG. 8 is a flowchart illustrating a data storage processing for the attribute database;

FIG. 9 is a diagram illustrating viewers or passersby within a photographing area of a camera unit; and

FIG. 10 is a flowchart illustrating a content display schedule generation processing for the signage terminal.

### DETAILED DESCRIPTION

In accordance with an embodiment, an information distribution apparatus includes an information input section, a category determination section, a storage section, a content selection section, a time schedule creation section and a distribution section.

The information input section inputs information of a person within a specified range from a signage terminal which reproduces a content data to display it. The category determination section determines the category of the person based on the information of the person inputted from the information input section. The storage section collects a statistics data on the determination result of the category determination section for each unit time in association with day and time of the week to store the statistics data in a first storage section as attribute tendency information of the person per unit time. The content selection section selects the content data to which meta-information relating to the attribute tendency information per unit time stored in the first storage section is added, with reference to a second storage section which stores the content data and the meta-information serving as an attribute information associated with the content data at a specified timing. The time schedule creation section creates a time schedule for reproducing the content data by arranging the content data selected by the content selection section in a row according to the time along which the statistics data is collected. The distribution section distributes the content data to the signage terminal according to the time schedule.

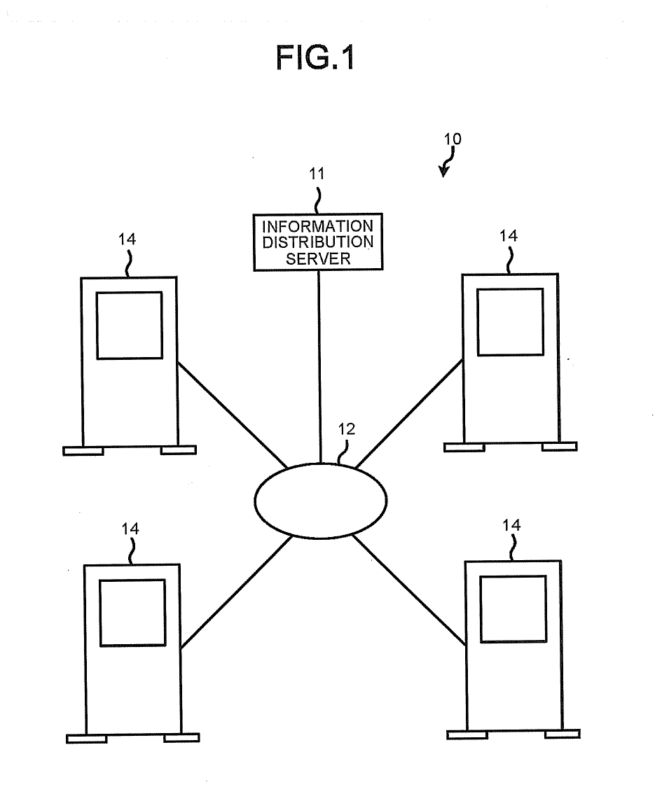

FIG. 1 is a block diagram illustrating a schematic configuration of a signage system 10 according to the embodiment. In the following description, a case in which the signage system 10 is arranged in a shopping mall is described.

The signage system 10 according to the present embodiment is mainly includes an information distribution server 11 as an information distribution apparatus, and a plurality of signage terminals 14.

The information distribution server 11 is connected to each signage terminal 14 via a communication network 12 such as a LAN (Local Area Network) and the like, to distribute content of information such as a commodity advertisement information or an event information and the like to the signage terminals 14, or to enable the signage terminals 14 to acquire the content by the access from the signage terminals 14.

The signage terminal 14 functions as a display terminal, it displays the content data which is distributed or acquired from the information distribution server 11 via the communication network 12.

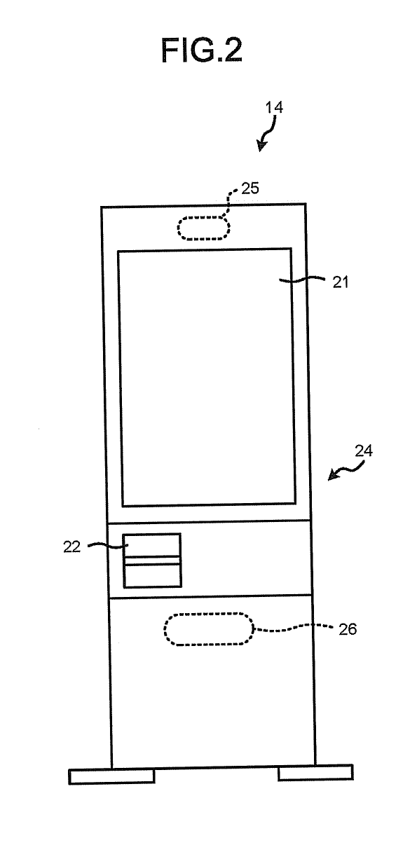

FIG. 2 is an external front view of the signage terminal 14. As shown in FIG. 2, the signage terminal 14 comprises a display unit 21 composed of a liquid crystal display or a plasma display, a printer unit 22 that issues various tickets and coupons and the like, and a housing 24 that holds the display unit 21 and the printer unit 22.

A camera unit 25 is housed at the upper part of the housing 24. The camera unit 25 is applied to a use in which a person is photographed to perform an image recognition and, the sex and age group of the person are specified to control variety of information which is distributed. A speaker unit 26 is housed at the lower part of the housing 24. The speaker unit 26 outputs various sounds such as a BGM (Background music), advertisement and the like. The processing such as an image recognition and the like is not carried out by the signage terminal 14, but may be conducted by a server at an upstream side such as an information distribution server 11 and the like.

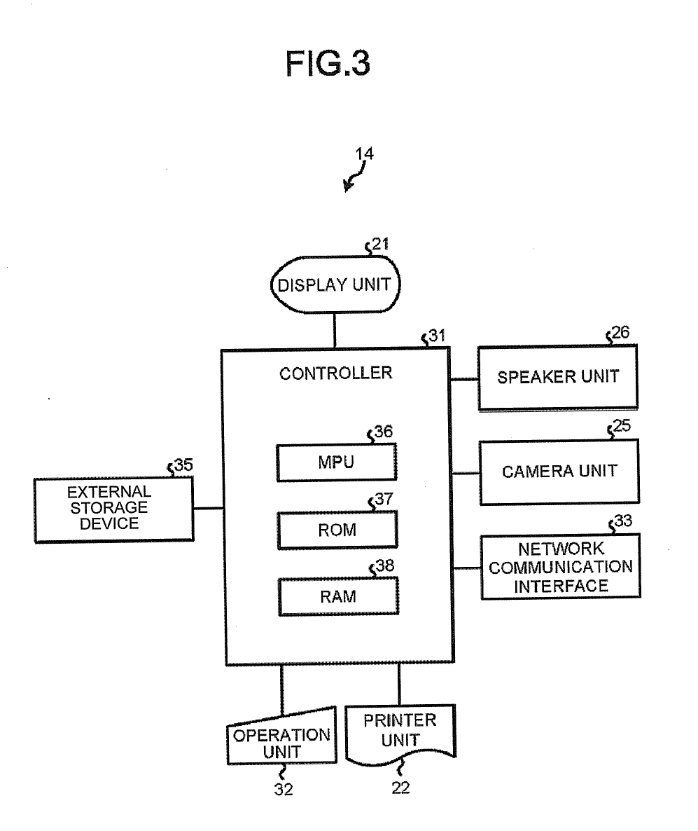

FIG. 3 is a block diagram illustrating the schematic configuration of the signage terminal 14. As shown in FIG. 3, the signage terminal 14 comprises the above-mentioned display unit 21, printer unit 22, camera unit 25, and speaker unit 26, as shown in FIG. 2. The signage terminal 14 further comprises a controller 31 that controls the whole operation of the signage terminal 14, an operation unit 32 through which a user carries out various operations, a network communication interface (IF) for conducting communication with the information distribution server 11 via the communication network 12, and an external storage device 35 that stores various data such as a content data and the like. The external storage device 35 includes an HDD (Hard Disk Drive) and an SSD (Solid State Drive) and the like.

The controller 31 comprises an MPU (Micro Processing Unit) 36 that controls the whole operation of the controller 31, a ROM (Read Only Memory) 37 that stores a control program for the MPU 36, and a RAM (Random Access Memory) 38 that temporarily stores various data. Then, the MPU 36 of the controller 31 executing the control program stored in the ROM 37, displays the content data distributed from the information distribution server 11 via the communication network 12 on the display unit 21. The operation unit 32 may be composed of various kinds of switches and buttons and the like, or it may be integrated with the display unit 21 as a touch panel.

By the above-described structure, the signage terminal 14 basically receives or acquires a plurality of content data pre-set in the information distribution server 11 as a reproduction schedule or a display schedule. Then, the signage terminal 14 displays advertisement information (a motion image that a commodity subject to the advertisement is photographed, or a written message that introduces or describes a commodity) relating to the commodity subject to the advertisement (hereinafter referred to as an “advertising commodity”) as a content data on the display unit 21, or outputs a voice message that introduces or explains the advertising commodity via the speaker unit 26.

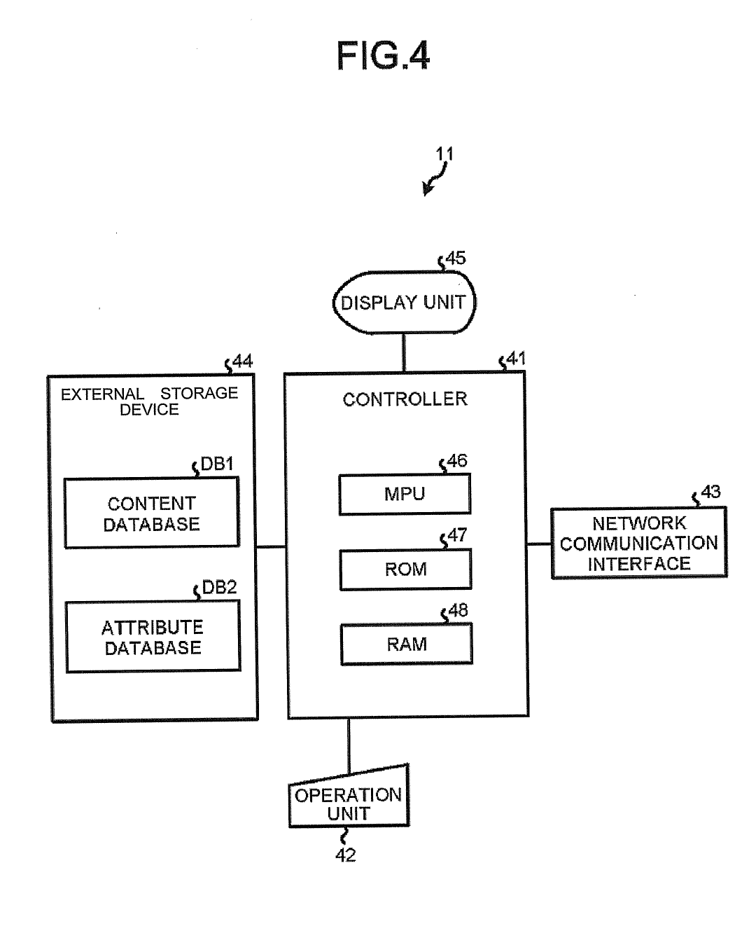

The information distribution server 11 will be described. FIG. 4 is a block diagram illustrating the schematic configuration of the information distribution server 11. As shown in FIG. 4, the information distribution server 11 includes a controller 41 that controls the whole operation of the information distribution server 11, an operation unit 42 having a keyboard and/or mouse for the user who carries out various operations, a network communication interface (IF) 43 for carrying out a communication with the signage terminals 14 via the communication network 12, an external storage device 44 that stores various data and control programs, and a display unit 45 such as a liquid crystal display. The external storage device 44 includes an HDD (Hard Disk Drive) and an SSD (Solid State Drive) and the like.

The controller 41 comprises an MPU 46 that controls the whole operation of the controller 41, a ROM 47 that stores a control program for operating the MPU 46, and a RAM 48 that temporally stores various data.

The MPU 46 controls the operation of various components by executing a control program, developed in the RAM 48, which is stored in the ROM 47 or the external storage device 44, and meanwhile the controller 41 controls the transmission/reception of various data, such as a content data, distributed to each of signage terminals 14 via the network communication IF 43 and the communication network 12.

The external storage device 44 stores a content database DB1 accumulating the content data. In the present embodiment, the content database DB1 is stored in the external storage device 44 of the information distribution server 11, but it is not limited to this, for example, the content database DB1 may be stored in a storage device (not shown) connected to the information distribution server 11 via the communication network 12.

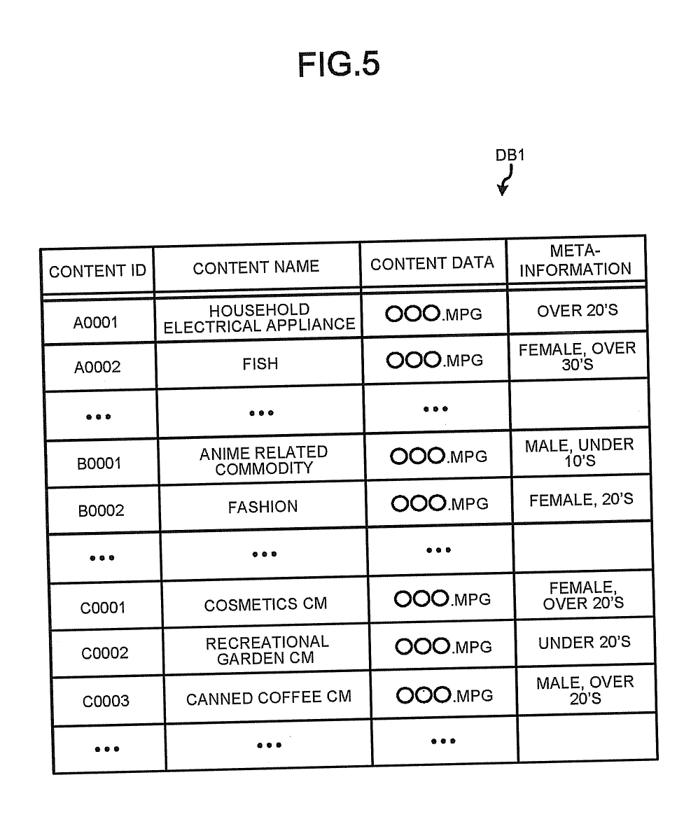

FIG. 5 is a diagram illustrating the components of the data stored in the content database DB1. As shown in FIG. 5, a content ID serving as identification information for identifying the content, a name of the content identified with the content ID, a content data identified with the content ID, and a meta-information added to the content data are stored in the content database DB1 serving as a second storage section.

As shown in FIG. 5, an attribute information as a meta-information, for example, a “male, under 10's,” of a viewer who stops at the signage terminal 14 (hereinafter referred to as a viewer) or a passerby who passes in front of the signage terminal 14 (hereinafter referred to as a passerby) is associated with a content name, for example, an “anime related commodity”. Moreover, as a meta-information, the attribute information, for example, a “female of 20's” of the viewer or the passerby is associated with a “fashion”, for example.

In the information distribution server 11, an attribute database DB2 is stored in the external storage device 44. The attribute database DB2 stores a result (collected statistics), in which attribute information per unit time including not only the attribute information of a viewer who stops at the signage terminal 14 but also the attribute information of a passerby who passes in front of the signage terminal 14 is collected for each day and time of the week, in association with day and time of the week. In the present embodiment, the attribute database DB2 is stored in the external storage device 44 of the information distribution server 11, but it is not limited to this. The attribute database DB2 may be stored in a storage device (not shown) connected to the information distribution server 11 via the communication network 12.

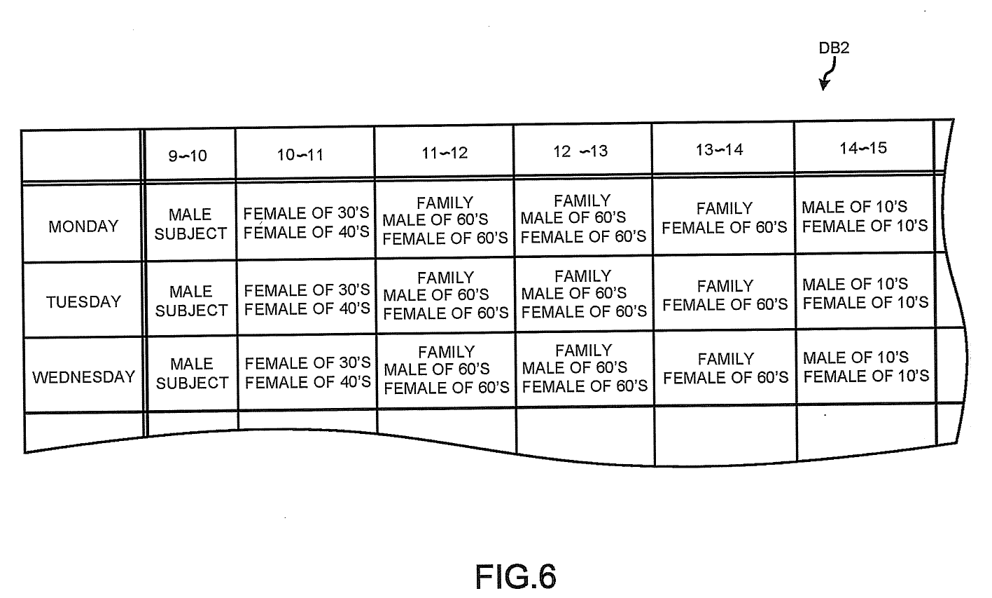

FIG. 6 is a diagram illustrating the components of the data accumulated in the attribute database DB2. As shown in FIG. 6, attribute tendency information of a viewer or a passerby (sex, age, number of persons, group type and the like) per statistical unit time (for example, 30 minutes, 1 hour and the like) is accumulated in the attribute database DB2 serving as a first storage section in association with day and time of the week.

As shown in FIG. 6, 9 a.m. to 10 a.m. (morning time) on weekdays is classified to a “male-majority” in the attribute tendency information, and 12 a.m. to 1 p.m.(day time) on weekdays is classified to a “family”, a “male of 60's” or a “female of 60's” in the attribute tendency information, for example.

The characteristic function of the information distribution server 11 i.e. the information distribution apparatus according to the present embodiment will be described. Schematically, as mentioned above, the information distribution server 11 accumulates the attribute information of a viewer and a passerby in association with day and time of the week. Thus, since the meta-information contained in the content data is retrieved based on the attribute information, an optimal content can be selected according to the time and then a reproduction schedule of the selected content can be created, and meanwhile the optimal content selected can also be distributed to the signage terminals 14 according to the time.

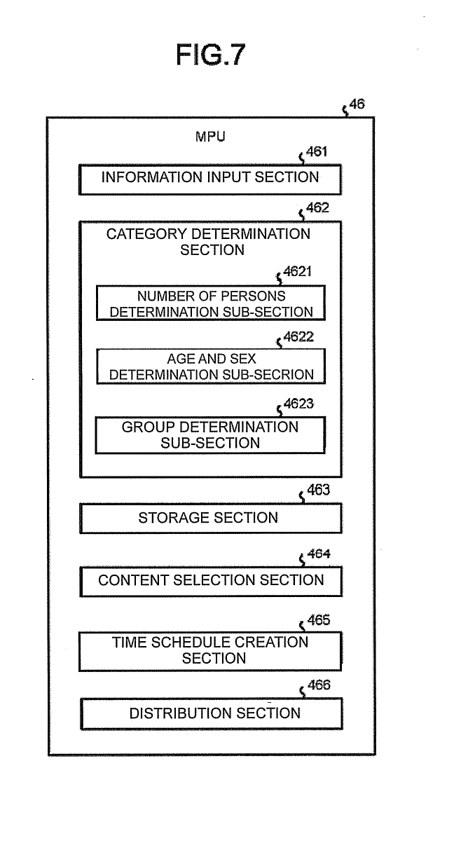

FIG. 7 is a block diagram illustrating the functional configuration of the information distribution server 11. The controller 41 enables the MPU 46 to operate according to a control program stored in the ROM 47. Thus, as shown in FIG. 7, the controller 41 functions as an information input section 461, a category determination section 462, a storage section 463, a content selection section 464, a time schedule creation section 465, and a distribution section 466.

The information input section 461 inputs information of a person within a specified range to the signage terminals 14. In the present embodiment, the information input section 461 acquires information of the viewer who stops at the signage terminal 14 and the passerby who passes in front of the signage terminal 14 from an image data captured by a camera unit 25 arranged at the signage terminal 14.

The category determination section 462 determines the category of a viewer and a passerby based on the information of the viewer and the passerby input by the information input section 461. As shown in FIG. 7, the category determination section 462 includes a number of persons determination sub-section 4621, an age and sex determination sub-section 4622, and a group determination sub-section 4623.

The number of persons determination sub-section 4621 determines the number of viewers and passersby based on the information of the viewer and the passerby input by the information input section 461. The age and sex determination sub-section 4622 carries out determination of age and sex of the viewer and the passerby based on the information of the viewer and the passerby input by the information input section 461. The group determination sub-section 4623 carries out determination of group of the viewer and the passerby based on the determination result in the number of persons of the viewer and the passerby acquired from the number of persons determination sub-section 4621 and the determination result in age and sex of the viewer and the passerby acquired from the age and sex determination sub-section 4622.

The storage section 463 collects statistics on the determination result of the category determination section 462 for each unit time according to day and time of the week and stores the collected statistics in the attribute database DB2 as the attribute tendency information of viewers and passersby per unit time.

The content election section 464 selects the content data to which a meta-information relating to the attribute tendency information of a viewer and a passerby per unit time stored in the attribute database DB2 is added, with reference to the content database DB1.

The time schedule creation section 465 arranges the content data selected by the content selection section 464 in a row according to the time along which the statistics is collected, to create the content reproduction time schedule.

The distribution section 466 distributes the content data to the signage terminals 14 according to the time schedule created by the time schedule creation section 465.

A content display processing in the above-described signage system 10 according to the present embodiment will be described. First, a data storage processing in the attribute database DB2, i.e., a part of the content display processing, is described.

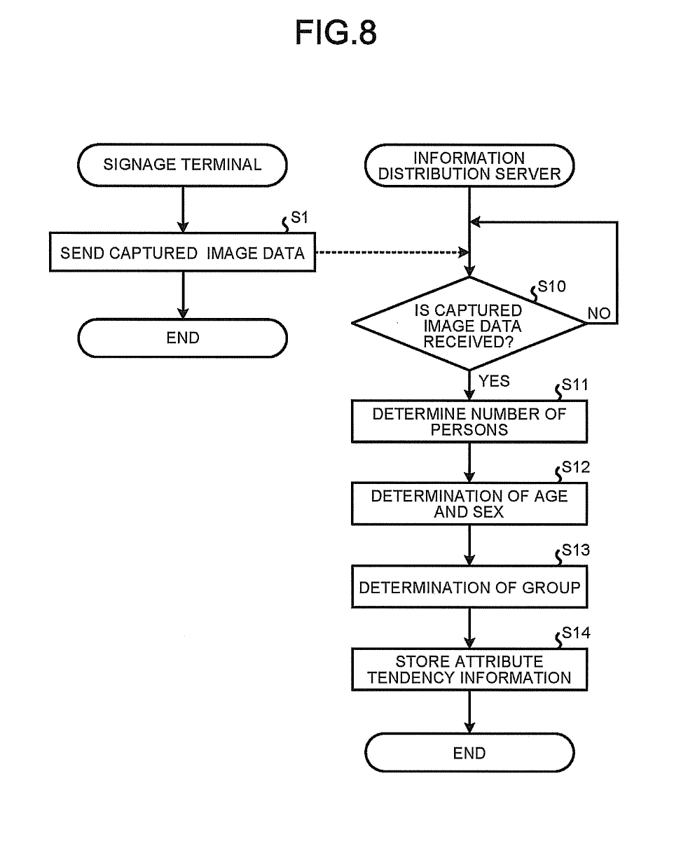

FIG. 8 is a flowchart illustrating the data storage processing in the attribute database DB2. As shown in FIG. 8, first, the MPU 36 of the signage terminal 14 sends the image data of a viewer or a passerby captured by the camera unit 25 to the information distribution server 11 at a specified timing or a specified intervals (for example, one-minute intervals) (ACT S1).

When the information input section 461 of the information distribution server 11 receives the image data of the viewer or the passerby captured by the camera unit 25 at the specified timing (Yes in ACT S10), then the number of persons determination sub-section 4621 carries out determination for the number of the viewers or the passersby based on the silhouette of the viewer or the passerby within the image data received (ACT S11).

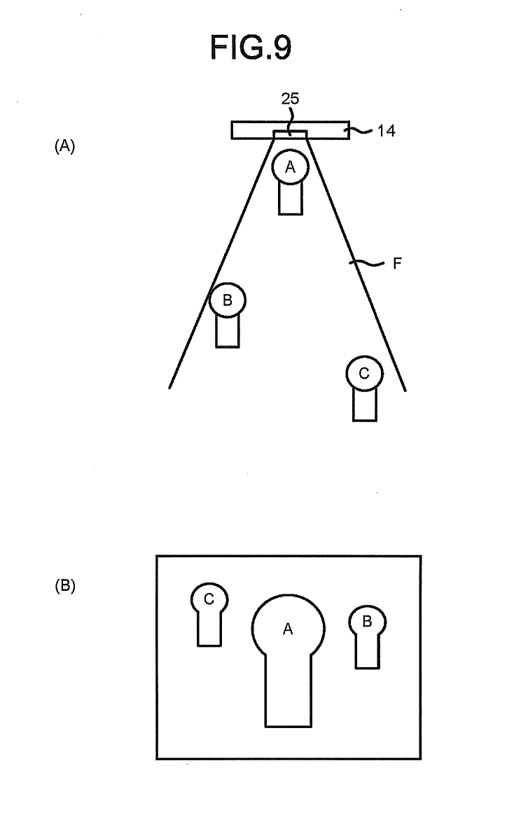

FIG. 9 is a diagram illustrating the viewer or the passerby within the imaging area (specified range) of the camera unit of the signage terminal 14. FIG. 9(A) illustrates a positional relationship between the imaging area and the viewer or the passerby, and FIG. 9(B) illustrates the silhouettes of the viewer or the passerby in the image data.

As shown in FIG. 9(A), in case that a plurality of persons A, B and C who are the viewer or the passerby are in the imaging area F of the camera unit 25, three silhouettes of the A, B and C are respectively recognized in the image data as shown in FIG. 9(B). The determination of the number of persons is carried out for each viewer or passerby displayed in the image data shown in FIG. 9(B) to determine any number of persons within the range in which the size of the viewer or the passerby is displayed so that the age and sex of the viewer or the passerby can be determined by the age and sex determination sub-section 4622 described later.

In the recognition of a person's silhouette, for example, in case that there are parts corresponding to head, body and limb (arms and legs) in the image data, the number of persons determination sub-section 4621 recognizes the area in which those parts are connected to each other as a person' s silhouette. Or, in case that there are parts corresponding to a human's face, i.e., eye, nose and mouth, in the image data, the number of persons determination sub-section 4621 recognizes the area extending from the face as a person's silhouette. The number of persons determination sub-section 4621 determines the number of the viewers or the passersby within the imaging area F based on the recognized person's silhouette.

Returning to the flowchart of FIG. 8, when the number of persons determination sub-section 4621 determines the number of the viewers or the passersby, the age and sex determination sub-section 4622 carries out the determination of age and sex of each viewer or passerby recognized by the number of persons determination sub-section 4621 (ACT S12). As an age and sex determination method for a viewer or a passerby by the age and sex determination sub-section 4622, the following well known method can be adopted. In such a well known method, for example, the feature amount is extracted from a facial image of each viewer or passerby in the image data from the camera unit 25, and the age and sex of that person is determined based on the feature amount.

The group determination sub-section 4623 carries out a group determination of the viewer or the passerby based on the number of the viewers or the passersby obtained from the number of persons determination sub-section 4621 and the determination result of age and sex of the viewer or the passerby obtained from the age and sex determination sub-section 4622 (ACT S13).

For example, in case that the viewer or the passerby is one, the group determination sub-section 4623 determines he or she as a “male of early 20's” or a “female of late 30's” and the like. In case that the viewer or the passerby are two of male and female and the age group thoseof is from “late 10's” to “early 20's”, the group determination sub-section 4623 determines them as a “couple”, and in case that the two are male and female and the age group thoseof is “late 20's”, they are determined as a “husband and wife”. Further, in case that a group includes at least one infant or child and at least one adult, the group determination sub-section 4623 determines them as a “family”. In addition, in case that a group includes only more than two males or females of the same age group, the group determination sub-section 4623 determines them as a “friends”.

On the other hand, in case that there is a group to which the above-mentioned groups (“couple”, “husband and wife”, “family”, “friends”) are not applicable, the group determination sub-section 4623 determines it to one of three groups of a “male-majority”, a “female-majority” and an “unspecified persons” according to the determination result of sex of the viewer or the passerby.

As mentioned above, the group determination sub-section 4623 classifies the viewer or the passerby into groups of a “male of early 20's”, a “female of late 30's”, a “couple”, a “husband and wife”, a “family”, a “friends”, a “male-majority”, a “female-majority”, an “unspecified persons” and the like according to the number of persons, and sex, and age group of the viewer or the passerby.

The storage section 463 collects a statistics on the determination results from the group determination sub-section 4623 per unit time (for example, 30 minutes, 1 hour and the like) in association with day and time of the week, and stores it as the attribute tendency information (sex, age, number of persons, group type and the like) of the viewer or the passerby per unit time in the attribute database DB2 (ACT S14). Accordingly, by the above-descriptions, the data storage processing to the attribute database DB2 completes.

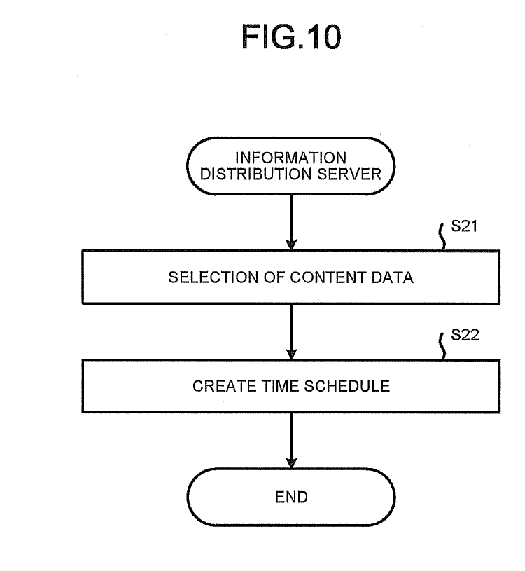

The content display schedule generation processing for the signage terminal 14 is described. FIG. 10 is a flowchart illustrating the content display schedule generation processing for the signage terminals 14.

As shown in FIG. 10, the content selection section 464 realized by the MPU 46 of the information distribution server 11 selects the content data to which a meta-information relating to the attribute tendency information of the viewer or the passerby per unit time stored in the attribute database DB2 is added, with reference to the content database DB1 stored in the external storage device 44 as shown in FIG. 5 at a specified timing or intervals (for example, once a week) (ACT S21).

The time schedule creation section 465 of the MPU 46 creates the time schedule for reproducing the content by arranging the content data selected by the content selection section 464 in a row according to the time along which the statistics is collected (ACT S22).

For example, in case that a plurality of content data are selected in a unit time, the time schedule creation section 465 arranges in a row all the selected content data so that they are reproduced within the time along which the statistics is collected. Further, within the time in which the statistics is collected, the content data may include only the selected content data that is repetitively reproduced, or other content data besides the selected content data.

The distribution section 466 of the MPU 46 of the information distribution server 11 distributes the content data to the signage terminal 14 according to the time schedule created in this way to enable the signage terminal 14 to execute reproduction of the content data.

According to the signage system 10 of the embodiment described above, the attribute tendency information (sex, age, number of persons, group type and the like) of a viewer, who stops at the signage terminal 14 or a passerby, who passes in front of signage terminal 14, whose image is captured by the camera unit 25 of the signage terminal 14 is stored in association with day and time of the week to select the content data to which the meta-information relating to the attribute tendency information is added, and meanwhile the selected content data is arranged in a row according to the time along which the statistics is collected to create the time schedule for the content reproduction to reproduce the content data. In this way, an optimal content is selected according to the time to create the reproduction schedule, and meanwhile since the optimal content can be distributed to the signage terminal 14 according to the time, an effective and efficient advertisement by the content display of the signage terminal 14 can be carried out also for the passerby who passes in front of the signage terminal 14.

In the above-mentioned embodiment, the camera unit 25 that captures the image of a viewer within the imaging are is used as the information input section 461 that inputs information of the viewer or the passerby, but it is not limited to this, an RFID reader and the like may also be used. In case that the RFID reader is used, information such as sex and age of the customer is stored along with a customer ID in a storage medium such as a membership card or a cell-phone possessed by the viewer. Then, the RFID reader reads out the information of the sex and the age group of the viewer or the passerby from the storage medium of the viewer or the passerby within the communication range of the wireless communication. Based on the read out information of the passerby or the viewer, the number of persons (viewer or passerby), sex and age group and the like thereof are determined and the group determination sub-section 4623 determines the group of the viewer or the passerby in the same way as the above-mentioned embodiment. Then, based on the determined group of the viewer or the passerby, the content selection section 464 selects the display content, and the time schedule creation section 465 creates the time schedule for reproducing the content by arranging the selected content data in row according to the time along which the statistics is collected.

In the present embodiment, the signage system 10 mainly including the information distribution server 11 and a plurality of signage terminals 14 is used, but it is not limited to this. For example, the signage terminal 14 may be used as the information display system, and thus the signage terminal 14 executes the processing operations of the information distribution server 11.

The program executed in the information distribution server 11 of the present embodiment is recorded into a computer readable recording media such as a CD-ROM, a flexible disk (FD), a CD-R, a DVD (Digital Versatile Disk) and the like in a form of an installable or executable file.

The program executed in the information distribution server 11 of the present embodiment is stored in a computer connected to a network such as Internet, and the program may also be downloaded via a network. Moreover, the program executed in the information distribution server 11 of the present embodiment may also be provided and distributed via a network such as Internet.

Although several embodiments have been described, these embodiments are represented as examples, and they are not intended to limit the scope of the invention. These novel embodiments can be implemented in other various forms. Various omissions, replacements and modifications can be conducted without departing from the gist of the invention. These embodiments or those variations are included in the scope or gist of the invention, and also included in the scope described in the claims and their equivalents.

What is claimed is:

1. An information distribution apparatus, comprising:
an information input section configured to input information of a person within a specified range from a signage terminal which reproduces a content data to display it;
a category determination section configured to determine the category of the person based on the information of the person inputted from the information input section;
a storage section configured to collect a statistics data on the determination result of the category determination section for each unit time in association with day and time of the week, and to store the statistics data in a first storage section as attribute tendency information of the person per unit time;
a content selection section configured to select the content data to which meta-information relating to the attribute tendency information per unit time stored in the first storage section is added, with reference to a second storage section which stores the content data and the meta-information serving as an attribute information associated with the content data at a specified timing;
a time schedule creation section configured to create a time schedule for reproducing the content data by arranging the content data selected by the content selection section in a row according to the time along which the statistics data is collected; and
a distribution section configured to distribute the content data to the signage terminal according to the time schedule.

2. The information distribution apparatus according to claim 1, wherein the category determination section includes a number of persons determination sub-section configured to determine the number of persons based on the information of the person inputted by the information input section, an age and sex determination sub-section configured to determine age and sex of the person based on the information of the person inputted by the information input section, and a group determination sub-section configured to determine group of the person based on the determination result of the number of the persons from the number of persons determination sub-section and the determination result of the age and sex of the person from the age and sex determination sub-section.

3. The information distribution apparatus according to claim 1, wherein the information input section acquires the information of the person from an image data captured by a camera unit arranged in the signage terminal.

4. An information distribution apparatus according to claim 3, wherein the person whose information is obtained from the image data by the information input section includes a viewer who stops at the signage terminal and a passerby who passes in front of the signage terminal.

5. A signage system, comprising:
a signage terminal configured to reproduce a content data to display it; and
an information distribution apparatus, set forth in claim 1, that is connected to the signage terminal via a communication network.

6. A method for distributing a content data by an information distribution apparatus having first and second storages, including:
inputting information of a person within a specified range from a signage terminal which reproduces a content data to display it;
determining category of the person based on the inputted information of the person;
collecting a statistics data on the determination result of the category of the person for each unit time in association with day and time of the week to store the statistics data in the first storage as attribute tendency information of the person per unit time;
selecting the content data to which meta-information relating to the attribute tendency information per unit time stored in the first storage is added, with reference to a second storage which stores the content data and the meta-information serving as an attribute information associated with the content data at a specified timing;
creating a time schedule for reproducing the content data by arranging the selected content data in a row according to the time along which the statistics data is collected; and
distributing the content data to a signage terminal according to the time schedule.
